(19) United States
(12) Patent Application Publication
(10) Pub. No.: US 2025/0041161 A1
(43) Pub. Date: Feb. 6, 2025

(54) NIPPLE AND NIPPLE ASSEMBLY

(71) Applicant: Mayborn (UK) Limited, Newcastle Upon Tyne (GB)

(72) Inventors: Simon Lewis Bilton, New Castle Upon Tyne (GB); Grace McAlpine Kane, Newcastle Upon Tyne (GB); Matthew Scott Kettyle, Newcastle Upon Tyne (GB); Blake John Parkinson, Newcastle Upon Tyne (GB); Nicholas Cudworth, Newcastle Upon Tyne (GB); Joshua Hume, Newcastle Upon Tyne (GB)

(21) Appl. No.: 18/708,459

(22) PCT Filed: Nov. 11, 2022
(86) PCT No.: PCT/GB2022/052862

§ 371 Date: May 8, 2024

(30) Foreign Application Priority Data
Nov. 12, 2021 (GB) 2116375.3

(51) Int. Cl. A61J 11/00; A61J 11/04

(52) U.S. Cl. CPC A61J 11/005; A61J 11/006; A61J 11/045

(57) ABSTRACT

A nipple for attachment to an external component, for example a container. The nipple comprises a base portion for attachment to the external component. The nipple also comprises a breast portion extending from the base portion. The nipple also comprises an areola portion extending from the breast portion. The nipple also comprises a teat portion extending from the areola portion. The breast portion extends at a first angle relative to an axis of the base portion and the areola portion extends at a second angle relative to the axis of the base portion, wherein the first angle is greater than the second angle.

This invention relates generally to a nipple or a teat. More specifically, although not exclusively, this invention relates to a nipple for attachment to a container.

Nipples, or teats, simulate the operation of a breast to provide comfort, sustenance, or both, to an infant. In use, the nipple is inserted into the infant's mouth, and the infant suckles on the nipple. If the nipple is connected to a container, then sustenance (e.g. food or drink) inside of the container can be fed to the infant through the nipple. This technique is commonly known as bottle-feeding and aims to simulate breast-feeding. If the nipple is connected to a comforter, such as a soother (also known as a pacifier or dummy), then the infant is comforted by suckling on the soother in the same way that the infant might be comforted during breast-feeding.

Nipples generally have a base portion for connection to a container or comforter, a teat portion which, in normal use, fully enters the infant's mouth, and an areola portion located between the teat portion and the base portion. The infant will typically latch onto the areola portion such that the infant's lips form a seal around the areola portion.

A drawback of using a nipple to provide sustenance is that, if the infant's latch is suboptimal, or if the infant's lips become unsealed from the areola portion, then air may enter the infant's mouth. In turn, the infant may swallow the air which might cause discomfort, for example bloating, wind, reflux and/or colic. A further drawback of using a nipple to provide sustenance is that this can lead to the infant becoming less able to breastfeed, for example due to becoming less able to establish an effective latch on a breast. This is known as nipple confusion.

Nipple confusion and poor latching can be somewhat averted by ensuring optimal use of the nipple during bottle-feeding. During optimal bottle-feeding, the infant's lips seal around the areola portion of the nipple during latching, and the teat portion of the nipple abuts the roof of the infant's mouth. The infant then moves their bottom jaw back-and-forth, such that their tongue rubs against the teat portion and/or the areola portion. This back-and-forth movement of the lower jaw creates what is known, in the art, as stripping action. This optimal bottle-feeding resembles breast feeding, and so reduces the likelihood of the occurrence of nipple confusion and helps to maintain a secure latch around the areola portion.

However, establishing an optimal latch is challenging, as is maintaining optimal bottle-feeding. This is because the nipple must be correctly inserting into the infant's mouth to the infant to establish an effective latch, and the bottle must be maintained in the correct orientation, relative to the infant, throughout. Often the person holding the bottle inserts the bottle into the infant's mouth in a suboptimal manner, holds the bottle in a suboptimal orientation, or the bottle is moved out of the optimal orientation during the feed. This can lead to numerous negative effects, such as the teat portion moving away from the roof of the infant's mouth, as well as a poor latch around the areola portion, which may allow air into the infant's mouth whilst also causing nipple confusion.

It would therefore be advantageous to provide a nipple which overcame at least some of the aforementioned drawbacks.

According to a broad aspect of the invention there is provided a nipple comprising a breast portion which extends from a base portion of the nipple at a first angle and an areola portion which extends from the breast portion at a second angle.

The first angle may be greater than the second angle.

The base portion may be configured for attachment to an external component, for example a comforter or a container (e.g. an infant drinking vessel). The base portion may define an axis. The first angle, at which the breast portion extends from the base portion, may be relative to the axis of the base portion. The second angle, at which the areola portion extends from the breast portion, may be relative to the axis of the base portion.

The nipple may further comprise a teat portion which extends from the areola portion.

According to an aspect of the invention, there is provided a nipple comprising:
a base portion for attachment to an external component, for example a comforter or a container (e.g. an infant drinking vessel);
a breast portion extending from the base portion;
an areola portion extending from the breast portion; and
a teat portion extending from the areola portion;
wherein the breast portion extends at a first angle relative to an axis of the base portion and the areola portion extends at a second angle relative to the axis of the base portion, wherein the first angle is greater than the second angle.

Advantageously, the areola portion may extend at a smaller angle relative to the axis of the base portion than if the breast portion were not present, or if the breast portion and the areola portion extended at substantially the same angle. This means that the areola portion may be closer to parallel with the axis of the base portion, and so the infant may be able to establish a deeper and more secure latch around the areola portion. This may reduce the risk of unsealing of the infant's lips, thereby reducing the likelihood that the infant swallows air. This may also decrease the risk of nipple confusion, because the infant is able to establish and maintain a deep and secure latch, as they would during breast-feeding. Providing a breast portion and an areola portion with different angles may also provide some articulation of the areola portion relative to the base portion, offering some versatility if a container, to which the nipple is attached in use, is held in a suboptimal orientation. This may allow the infant to establish and maintain an effective and secure latch, even with this suboptimal orientation. Providing an areola portion which is closer to parallel with the axis of the base portion may allow the infant to urge the teat portion to the roof, or palate, of their mouth by applying pressure to the areola portion using their top teeth and/or gums, and/or using their top lip. This advantage may be more pronounced than nipples wherein the areola portion is further from parallel relative to the axis of the base portion, as pressure applied to the areola portion will cause less movement of the teat portion toward the roof of the mouth. Providing first and second angles, as in the aspect of the invention, may also better simulate breast-feeding, as the infant's lips may abut the breast portion while their mouth is latched onto the areola portion, as might be the case in breast-feeding.

The first angle may be an average angle between the breast portion and the axis of the base portion. The second angle may be an average angle between the areola portion and the axis of the base portion. The breast portion may be substantially tapered in shape. The first angle may be a taper angle. The areola portion may be substantially tapered in shape. The second angle may be a taper angle.

The axis of the base portion may be referred to as a central axis of the base portion. The base portion may be circular in cross-section. The base portion and the breast portion may be substantially coaxial. The base portion and the areola portion may be substantially coaxial. The base portion and the teat portion may be substantially coaxial. The nipple may be substantially axisymmetric. The nipple may comprise an outer wall. The nipple may comprise a hollow, shell-shape which has an opening through the base portion. The opening may allow fluid to enter the nipple from a container, when the nipple is connected to a container. The nipple may comprise an opening at the teat portion. The opening at the teat portion may allow liquid to pass therethrough when an infant suckles on the nipple.

The nipple may comprise a valve through a wall of the nipple. The valve may be located through the breast portion. The valve may fluidly couple the inside and the outside of the nipple. The valve may be a one-way valve which allows air to pass through the valve and into the nipple, while preventing liquid from passing out of the nipple through the valve. The nipple may be substantially axisymmetric with the exception of the valve.

The nipple may have an outwardly extending bellow shape at the position where the breast portion meets the base portion. The bellows shape may be provided by a tapered section of the base portion. The tapered section of the base portion may provide a circumferential groove at the base portion. A securing ring may be received or receivable in the circumferential groove. The securing ring may be for securing the nipple to a container. The bellows shape may allow the areola portion and/or the breast portion to articulate relative to the base portion. Such articulation may improve the establishment and maintenance of an infant's latch on the nipple during feeding.

The breast portion and the areola portion may provide a latch portion.

The latch portion may comprise at least one elongate recess. The elongate recess may extend circumferentially around an inner surface of the latch portion. The at least one elongate recess may enhance the ability of the areola portion to articulate relative to the base portion. This articulation may enable an infant to establish and/or maintain an effective latch when the nipple is not orientated, relative to the infant's mouth, optimally. This may further reduce the risk of unsealing of the infant's lips from the latch portion and may reduce the risk of nipple confusion.

The latch portion may comprise a plurality of discrete, circumferentially spaced, elongate recesses. The plurality of discrete, elongate recesses may extend circumferentially around the inner surface of the latch portion. The plurality of discrete, elongate recesses may form a discontinuous ring of recesses. Providing a plurality of discrete recesses may provide an optimal balance between the stiffness and/or structural integrity of the nipple and nipple articulation and/or flexibility.

The discrete, elongate recesses may be arranged in a repeating pattern along the discontinuous ring.

The plurality of discrete, elongate recesses may be positioned at discrete positions along an axial direction of the latch portion. The plurality of discrete, elongate recesses may form a plurality of axially spaced, discontinuous rings of recesses. This may provide greater flexibility to the nipple, to allow a greater degree of articulation.

The plurality of discrete, elongate recesses may be arranged in a repeating pattern along each discontinuous ring.

The discrete, elongate recesses may be arranged along each discontinuous ring such that the recesses provide an alternating pattern with respect to the discontinuous rings.

The discrete, elongate recesses of at least two, adjacent ones of the discontinuous rings may be arranged such that ends of the discrete, elongate recesses are circumferentially offset from ends of the discrete, elongate recesses on the other one of the two, adjacent, discontinuous rings.

The discrete, elongate recesses of at least two, adjacent ones of the discontinuous rings may be arranged such that a centre point between any two adjacent, discrete, elongate recesses on one of the two adjacent, discontinuous rings is substantially circumferentially aligned with a circumferential centre point of one of the discrete, elongate recesses on the other one of the two, adjacent, discontinuous rings. This arrangement may provide greater flexibility by providing a nonlinear, axial loading path between the discrete, elongate recesses.

The discrete, elongate recesses of each discontinuous ring may be arranged such that ends of the discrete, elongate recesses are circumferentially offset from ends of the discrete, elongate recesses of any adjacent discontinuous rings.

A centre point between any two adjacent, discrete, elongate recesses on each of the discontinuous rings may be substantially circumferentially aligned with a circumferential centre point of one of the discrete, elongate recesses on any adjacent discontinuous rings.

The centre point between any two, adjacent, discrete, elongate recesses on one of the discontinuous rings is halfway between ends of the two, adjacent, discrete, elongate recesses on the discontinuous ring. The circumferential centre point of one of the discrete, elongate recesses is a point which is halfway along the elongate length of the recess. In other words, the circumferential centre point of one of the discrete, elongate recesses is a point which is halfway along the circumferential length of the recess.

One of the discontinuous rings may be located at a position where the breast portion joins the areola portion. Any further discontinuous rings may be located on the breast portion.

The plurality of discontinuous rings may be arranged concentrically. Each discontinuous ring may have a plane which is substantially perpendicular to a central axis of the latch portion. Each discontinuous ring may have a plane which is substantially perpendicular to the axis of the base portion.

The or each recess may provide a region of reduced wall thickness. The or each recess may be provided by a pocket on the inner surface of the latch portion. Providing a recess or recesses may be easy to mould and to clean, while providing enhanced flexibility.

The latch portion may have a smooth outer surface at the or each recess.

The breast portion may be frustoconical in shape.

The breast portion may comprise a plurality of portions. Each portion may have a different angle, relative to the axis of the base portion, to that of any adjacent portions. One of the plurality of portions, which is adjacent to the areola portion, may extend at the first angle. Any number of the plurality of portions of the breast portion may be frustoconical in shape. Each of the plurality of portions of the breast portion may be frustoconical in shape.

The areola portion may be frustoconical in shape.

The breast portion, the areola portion and the teat portion may be provided by a continuous outer wall. The breast portion, the areola portion and the teat portion may be provided by a unitary outer wall. The breast portion, the areola portion and the teat portion may be provided by a progressive outer wall.

The teat portion may extend from the areola portion at a shoulder portion. A diameter of the areola portion adjacent to the shoulder portion may be greater than a diameter of the teat portion adjacent to the shoulder portion. The shoulder portion may further enable the areola portion to be more parallel to the axis of the base portion, thereby further encouraging a deeper and more secure latch in the infant's mouth. The shoulder portion may also be more representative of a breast, and so further reduce the likelihood of nipple confusion.

The breast portion, the areola portion, the teat portion and the shoulder portion may be provided by a continuous outer wall. The breast portion, the areola portion, the teat portion and the shoulder portion may be provided by a unitary outer wall. The breast portion, the areola portion, the teat portion and the shoulder portion may be provided by a progressive outer wall.

The nipple may be provided by a continuous outer wall. The nipple may be provided by a unitary outer wall. The nipple may be provided by a progressive outer wall.

The teat portion may comprise a substantially cylindrical sidewall. The teat may comprise a sidewall which is flared outwardly in a direction away from the areola portion. The teat portion may comprise a substantially part-spherical, for example hemispherical, tip, the sidewall being located between the tip and the areola portion. A diameter of the tip may be greater than a diameter of the sidewall. The diameter of the tip may be greater than an average diameter of the sidewall. The diameter of the tip may be substantially the same as the diameter or the average diameter of the sidewall.

The nipple may further comprise at least one collapse resistant rib. The at least one collapse resistant rib may extend along, and substantially axially with respect to, the teat portion. The at least one collapse resistant rib may extend at least partially along the shoulder portion. The at least one collapse resistant rib may extend at least partially along the areola portion. The at least one collapse resistant rib may be provided by an inwardly projecting groove. The at least one collapse resistant rib may comprise a plurality of collapse resistant ribs equally spaced around the circumference of the nipple. The collapse resistant ribs may reduce the risk of complete collapse of the teat portion, such that the inner surface of the teat is prevented from self-sealing if the teat portion radially collapses. In other words, in the event hat the teat portion collapse, the ribs, may ensure that a fluid channel remains through the teat portion to allow the flow of fluid therethrough.

According to a second aspect of the invention, there is provided a nipple assembly for use with an infant drinking vessel, the nipple assembly including the aforementioned nipple and a collar. The collar may engage the base portion of the nipple, to secure the nipple to the infant drinking vessel, in use.

According to a third aspect of the invention there is provided a feeding assembly for use with an infant drinking vessel, the feeding assembly including the aforementioned nipple and a container. The base portion of the nipple may abut an opening of the container. The base portion of the nipple may seal against and/or around an opening of the container.

The feeding assembly may further comprise a collar for securing the nipple to the container. The collar may engage the base portion of the nipple, to secure the nipple to the infant drinking vessel, in use.

The collar may comprise an orifice for engaging the nipple. The collar may comprise an engagement portion configured for selective engagement with a container. The collar may be configured for removable engagement with a container. The collar may be configured so that the nipple assembly may be mounted to the mouth of a container. The collar may comprise a cover contacting portion for selectively mounting the assembly within a recessed volume of a cover. The collar may be configured so that the nipple assembly may be mounted within a recessed volume of a cover.

According to a fourth aspect of the invention there is provided a comforter assembly for comforting an infant, the comforter assembly including the aforementioned nipple.

According to an alternative aspect of the invention there is provided a nipple shield including a nipple according to the previous aspects of the invention.

Another aspect of the invention provides a computer program element comprising and/or describing and/or defining a three-dimensional design, e.g. of the nipple described above or an embodiment thereof. The three-dimensional design may be for use with a simulation means or an additive or subtractive manufacturing means, system or device.

The computer program element may be for causing, or operable or configured to cause, an additive or subtractive manufacturing means, system or device to manufacture the nipple described above or an embodiment thereof. The computer program element may comprise computer readable program code means for causing an additive or subtractive manufacturing means, system or device to execute a procedure to manufacture the nipple described above or an embodiment thereof.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

Embodiments of the invention will now be described by way of example only with reference to the accompanying drawings in which:

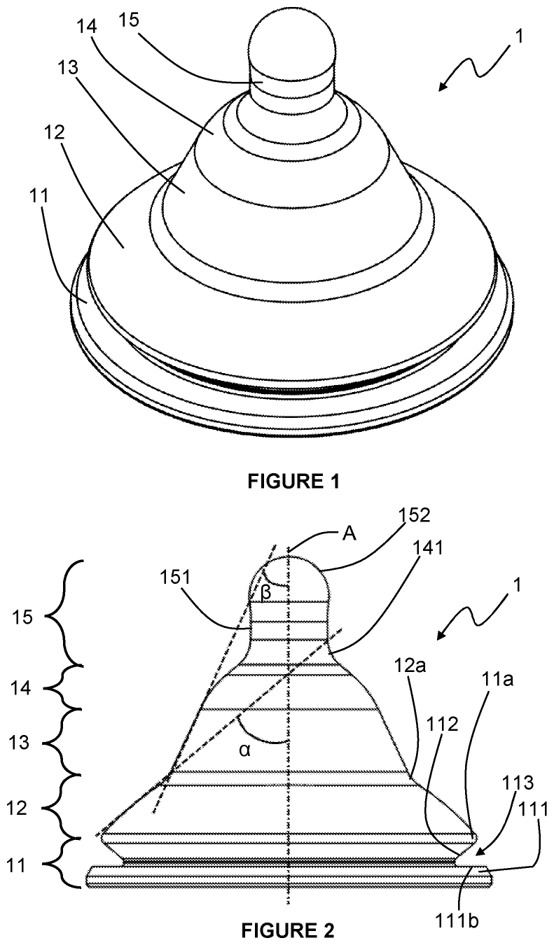

FIG. 1 is an isometric view of a nipple according to a first example;

FIG. 2 is a front view of the nipple of FIG. 1;

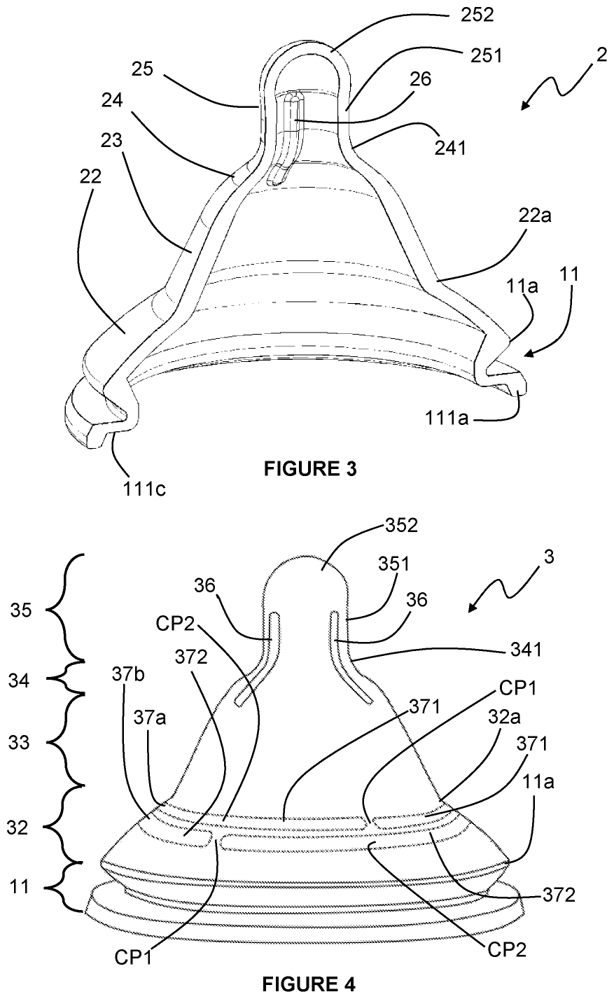

FIG. 3 is section view of a nipple according to another example;

FIG. 4 is a front view of a nipple according to another example;

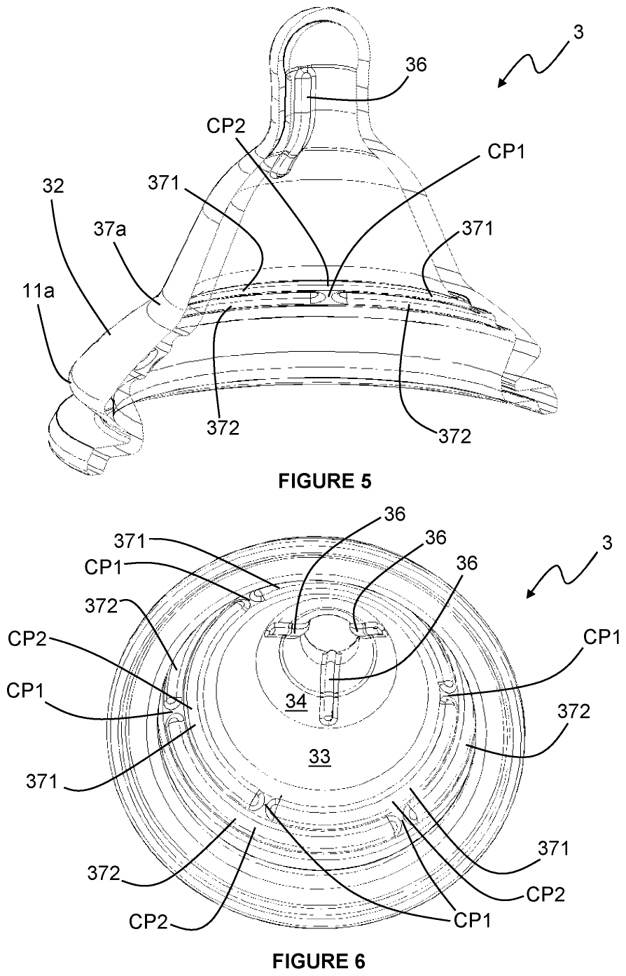

FIG. 5 is a section view of the nipple of FIG. 4;

FIG. 6 is a bottom view of the nipple of FIG. 4;

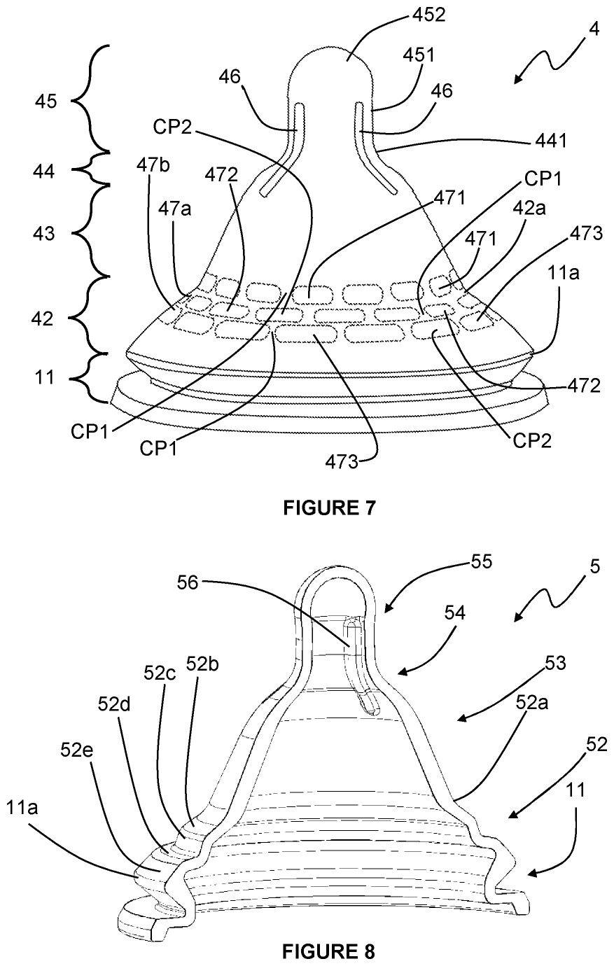

FIG. 7 is a front view of a nipple according to another example;

FIG. 8 is section view of a nipple according to another example; and

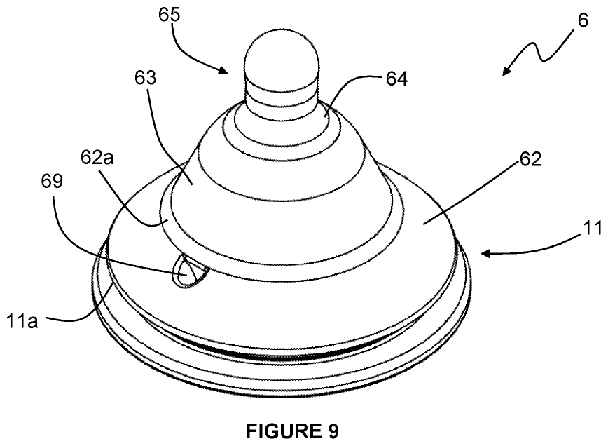

FIG. 9 is an isometric view of a nipple according to another example.

Referring now to FIGS. 1 and 2, there is shown a nipple 1. The nipple 1 is for attachment to an external component (not shown), which in this example is a container, for example an infant feeding bottle. Throughout the description reference is made to “upper”, “upwardly”, “lower” and “downwardly”, and these terms relate to the orientation of the nipple 1 when located on a container, such that the nipple 1 is located at the top of the container.

The nipple 1 has a base portion 11 which, in use, abuts and seals against an opening of the container. The nipple 1 has a breast portion 12 extending inwardly and upwardly from the base portion 11. The nipple 1 has an areola portion 13 extending inwardly and upwardly from the breast portion 12. The nipple 1 has a shoulder portion 14 extending inwardly and upwardly from the areola portion 13. The nipple 1 has a teat portion 15 extending upwardly from the shoulder portion 14. The areola portion 13 and the breast portion 12 may be collectively referred to as a latch portion. The base portion 11, breast portion 12, areola portion 13, shoulder portion 14 and teat portion 15 are formed of a continuous outer wall. The nipple 1 has a shell-like shape, being hollow in the centre. The nipple 1 is axisymmetric about an axis A of the base portion 11.

The base portion 11 has a sealing ring 111 which is located at a lower end of the nipple 1. The sealing ring 111 has a peripheral lip 111a (visible in FIG. 3 with reference to another example of a nipple) at the lower end, for sealing around an opening of the container, in use. The sealing ring 111 has a flat upper surface 111b for the abutment of a securing ring (not shown) thereagainst. The sealing ring 111 has a flat lower surface 111c (as visible in FIG. 3 with reference to another example of nipple) for abutment against a container. The base portion 11 has a tapered section 112 extending upwardly and outwardly from an innermost edge of the flat upper surface 111b, to define a circumferential groove 113 in the base portion 11. The tapered section 112 provides a bellows shape to the nipple.

The base portion 11 has a transition section 11a which is adjacent the breast portion 12, the transition section 11a having a concave outer surface. The transition section 11a extends upwardly from an upper edge of the tapered section 112 of the base portion 11.

The breast portion 12 extends inwardly and upwardly from an upper edge of the transition section 11a. In this example the breast portion 12 is substantially frustoconical in shape, albeit with a shallow, outwardly curved shape. The breast portion 12 extends at a first angle α relative to the axis A of the base portion 11. The first angle α is an average angle of an outer surface of breast portion 12 with respect to the axis A, as shown by the dashed line in FIG. 2.

The breast portion 12 has a transition section 12a located adjacent the areola portion 13, the transition section 12a having a convex outer surface. The areola portion 13 extends inwardly and upwardly from an upper edge of the transition section 12a. In this example the areola portion 13 is substantially frustoconical in shape. The areola portion 13 extends at a second angle β relative to the axis A of the base portion 11. The second angle β is an average angle of an outer surface of areola portion 13 with respect to the axis A, as shown by the dashed line in FIG. 2. The first angle α is greater than the second angle β.

The shoulder portion 14 is provided between the areola portion 13 and the teat portion 15. The shoulder portion 14 extends tangentially and upwardly from an upper edge of the areola portion 13 and curves inwardly towards the teat portion 15. The shoulder portion 14 has a convex portion 141 which leads into the teat portion 15. The diameter of a lower edge of the teat portion 15 is smaller than a diameter of the upper edge of the areola portion 13.

The teat portion 15 extends upwardly from the shoulder portion 14. The teat portion 15 has a sidewall 141 and a tip 152. The sidewall 151 is substantially cylindrical in shape, albeit flaring slightly radially outwardly in the upward direction. The tip 152 is substantially part-spherical, or substantially hemispherical, and extends from an upper edge of the sidewall 151. A diameter of the tip 152 is greater than an average diameter of the sidewall 151. The teat portion has an opening (not shown) in the tip 152, for allowing the passage of liquid therethrough.

The nipple 1 is manufactured using silicone, although it will be appreciated that any suitable material may be used. The silicone has a Shore hardness of between 30 A and 50 A. In this example the outer wall has a thickness of between 1.5 mm and 5 mm. It will be appreciated that the thickness of the outer wall, as well as the distribution of thicknesses, and the Shore hardness, may be altered to values not specified herein, to achieve desired properties of the nipple 1. In this example an outer diameter of the sealing ring 111 is around 70 mm, or more specifically 60.90 mm. However, it will be appreciated that any diameter of sealing ring 11 may be provided, to suit any container. The sealing ring 11 is the widest part of the nipple 1.

When secured to a container, the peripheral lip 11a of the nipple 1 is located around the periphery of an upper edge of an opening of the container such that the flat lower surface 111c of the sealing ring 111 abuts the top of the upper edge of the opening. The securing ring is inserted into the groove 113 of the base portion 11 and engaged with a threaded neck of the container. The securing ring is inserted into the groove 113 by compressing, as necessary, the breast portion 12 and areola portion 13, such that the breast portion 12 and areola portion 13 pass through the securing ring. As the securing ring is screwed onto the threaded neck of the container, the securing ring compresses the sealing ring onto the top of, and around the periphery of, the upper edge of the opening. This provides a liquid-tight, seal around the opening of the container. The nipple 1 is removed from the container by unscrewing the securing ring.

During feeding of an infant (not shown), the nipple 1, whilst secured to the container, is inserted into the infant's mouth. The infant's lips seal around the areola portion 13 and may also seal around, or at least abut, a part of the breast portion 12. Due to the first angle α being greater than the second angle β, the areola portion 13 is able to be closer to parallel with the axis A of the base portion 11, while maintaining the diameter of the base portion 11. In other words, providing a breast portion 12 and areola portion 13 with the first and second angles α, β respectively, enables the areola portion 13 to be closer to parallel with the axis A. This might be beneficial for enabling the infant to establish a deeper latch on the nipple 1, which might reduce the risk of unsealing of the infant's lips from the nipple 1. This may also reduce the risk of nipple confusion, as the arrangement might better resemble breast-feeding. Furthermore, by providing the areola portion 13 which is closer to parallel with the axis A, the areola portion 13 might be easier for the infant to latch onto than an areola portion 13 which is further from being parallel. The areola portion 13 is also able to articulate relative to the breast portion 12, due to the different angles of the breast portion 12 and the areola portion 13. Also, during feeding, the breast portion 12 is able to articulate about the base portion 11 due to the bellows shape as provided by the tapered section 112. During articulation, the tapered section 112 is able to move away from the securing ring. This may help to maintain a latch which better resembles breast-feeding, even if the container is held in a suboptimal orientation, or if the container is moved during a feed. Similarly, by providing the areola portion 13 which is closer to parallel with the axis A, the infant may be able to apply inward pressure to the areola portion 13 using their top gums/teeth and/or top lip, thereby encouraging the teat portion 15 against the roof of the mouth. This might better resemble breast feeding and so further reduces the likelihood of nipple confusion.

As the infant suckles on the nipple 1, liquid from the container passes into the nipple 1 and out through the opening in the teat portion 15. During optimal use, the teat portion 15 abuts the roof, or palate, of the infant's mouth. The infant's tongue will also abut, and rub against, the teat portion 15, shoulder portion 14 and areola portion 13. The shoulder portion 14 might better resemble a breast, and so this might further contribute to reducing the likelihood of nipple confusion. Furthermore, the shoulder portion 14 allows the areola portion 13 to be closer to parallel with the axis A, without the need to increase the diameter of the sidewall of the teat portion 15.

Referring now to FIG. 3 there is shown a nipple 2 according to another example. The nipple 2 of this example is similar to the nipple 1 described with reference to FIGS. 1 and 2. Like features are denoted with like reference numerals with a preceding ‘2’ instead of ‘1’, with the exception of the base portion 11, as this is consistent across all examples.

The nipple 2 of this example differs from the nipple 1 of the previous example in that there are provided three collapse resistant ribs 26, one of which is visible in FIG. 3 (and all three are visible in FIG. 6 with reference to a different example of nipple and are denoted with ‘36’). The ribs 26 are equally spaced around the circumference if the nipple 2. The ribs 26 are elongate in shape. The ribs 26 extend from adjacent the tip 252 of the teat portion 25 in a direction towards the base portion 11. The ribs 26, in this example, extend across the sidewall 251 of the teat portion 25, and across the shoulder portion 24, and terminate adjacent to the areola portion 23. The ribs 26 are provided by inwardly projecting grooves in the outer wall of the nipple 2.

The nipple 2 of this example is attached to a container, and is used in an infant's mouth, in the same way as the nipple 1 of the previous example. The ribs 26 of the nipple 2 of this example maintain a channel through the teat portion 25 in the event that the teat portion 26 collapses. Without the presence of the ribs 26, the teat portion 25 may self-seal in the event of collapse, thereby prevent the flow of liquid from the container to the infant's mouth.

Referring now to FIGS. 4 to 6, there is shown another example of a nipple 3. The nipple 3 of this example is similar to the nipples 1, 2 of previous examples. Like features are denoted with like reference numerals with a preceding ‘3’ instead of ‘2’ or ‘1’, with the exception of the base portion 11, as this is consistent across all examples

The nipple 3 of this example differs from the previous examples in that there are provided recesses in the breast portion 32. The recesses, in this example, are arranged in two concentric, spaced, rings 37a, 37b. The rings 37a, 37b have planes which are substantially perpendicular to the axis A of the base portion 11. The first ring 37a is located at the transition section 32a of the breast portion 32. The first ring 37a has three discrete, elongate recesses 371 which form a discontinuous ring, the discontinuous ring providing the first ring 37a. The second ring 37b is located in the breast portion 32, and has three discrete, elongate recesses 372 which form another discontinuous ring, the discontinuous ring providing the second ring 37b. The recesses 371, 372 of each ring 37a, 37b are arranged such that a centre point CP1 between the recesses 371, 372 on one of the rings 37a, 37b is substantially circumferentially aligned with a circumferential centre point CP2 of one of the recesses 371, 372 on the other ring 37a, 37b. In this way, the rings 37a, 37a have an alternating pattern of recesses 371, 372 in the axial direction of the base portion 11. Each recess 371, 372 is provided on the inner surface of the breast portion 32, and is in the form of a pocket, or groove. The breast portion 32 has a smooth outer surface in the regions of the recesses 371, 372.

The nipple 3 of this example is attached to a container and is used in the same way as the nipples 1, 2 of the previous examples. The areola portion 33 of the nipple 3 of this example is better able to articulate, relative to the base portion 11, than the nipples 1, 2 of the previous examples, due to the recesses 371, 372 in the breast portion 11. The alternating pattern of recesses 371, 372 provide a nonlinear loading path in the axial direction of the breast portion, thereby providing a greater degree of flexibility. This improved scope for articulation provides a more versatile nipple 3, enhancing the aforementioned benefits relating to establishing and maintaining an effective latch, and reducing the likelihood of nipple confusion.

Referring now to FIG. 7, there is shown a nipple 4 which is similar to the nipple 3 of the previous example. Like features are denoted with like reference numerals with a preceding ‘4’ instead of ‘3’, with the exception of the base portion 11, as this is consistent across all examples.

The nipple 4 of this example differs from that of the previous example in that there are provided three rings 47a, 47b, 47c of recesses 471, 472, 473. Further differentially, the recesses 471, 472, 473 are shorter, and so extend less distance around the circumference of the breast portion 42 and are present in a higher quantity. As in the previous example, the recesses 471, 472, 473 are arranged in an alternating pattern of recesses 471, 472 in the axial direction of the base portion 11, in that recesses 471, 472, 473 of each ring 47a, 47b are arranged such that the centre point CP1 between the recesses 471, 472, 473 on one of the rings 47a, 47b, 47c is substantially circumferentially aligned with the circumferential centre point CP2 of one of the recesses 471, 472, 473 on an adjacent one of the rings 471, 47b, 47c.

The nipple 3 of this example has the same benefit as the nipple 2 of the previous example, to a greater extent, due to there being one more ring 47a, 47b, 47c of recesses 471, 472, 473, and due to there being more, shorter recesses 471, 472, 473 in each ring 47a, 47b, 47c.

Referring now to FIG. 8 there is shown another example of nipple 5 which is similar to the nipples 1, 2 described with reference to FIGS. 1, 2 and 3. Like features are denoted with like reference numerals with a preceding ‘5’ instead of ‘1’ or ‘2’, with the exception of the base portion 11, as this is consistent across all examples. The nipple 5 of this example differs from those of FIGS. 1-3 in that the breast portion has four portions 52b, 52c, 52d, 52e. Each portion 52b, 52c, 52d, 52e has a different angle, relative to the axis A of the base portion 11, to that of any adjacent portions 52b, 52c, 52d, 52e. The topmost portion 52b, which is adjacent the areola portion 53, has the first angle α.

The nipple 5 allows articulation of the areola portion 53 relative to the base portion 11 due to the portions 52b, 52c, 52d, 52e of the breast portions 52 having different angles. This has the benefits associated with previous examples, which allow for articulation of the areola portion 53 with respect to the base portion 11.

Referring now to FIG. 9, there is shown another example of a nipple 6, which is similar to the example nipples 1, 2, 3, 4 described with reference to FIGS. 1 to 7. Like features are denoted with like reference numerals with a preceding ‘6’ instead of ‘1’, ‘2’, ‘3’ or ‘4’, with the exception of the base portion 11, as this is consistent across all examples. The nipple 6 of this example differs from those of previous examples in that there is a vent 69 providing in the breast portion 62. The vent 69 comprises a one-way valve (not shown). The vent allows air to enter a container, when the nipple 6 is attached thereto, during use. The vent 69 prevents liquid from leaving the container, through the vent 69, during use.

It will be appreciated that a vent, such as the vent 69 shown in FIG. 9, may be provided in the breast portion 52 of the nipple 5 shown in FIG. 8.

It will be appreciated by those skilled in the art that several variations to the aforementioned embodiments are envisaged without departing from the scope of the invention. For example, rings of recesses are provided on the areola portion and on the breast portion. In other examples differing numbers of recesses are provided in each ring. In other examples different numbers of rings are provided. By altering any or all of these variables, different amounts of flexibility, and different levels of articulation, can be realised, and these can be tailored to specific purposes. In other examples, each ring may comprises just one recess which extends around the entirety of the circumference of the nipple.

The examples of nipples described above with reference to the Figures do not describe the inclusion of a vent. It will be understood that a nipple according to any of the described examples may include a vent, for example an anti-colic vent to allow for better airflow and prevent the feeding infant ingesting excess air and suffering with gas pains or colic.

It will also be appreciated by those skilled in the art that any number of combinations of the aforementioned features and/or those shown in the appended drawings provide clear advantages over the prior art and are therefore within the scope of the invention described herein.

1. A nipple comprising:
a base portion for attachment to an external component;
a breast portion extending from the base portion;
an areola portion extending from the breast portion; and
a teat portion extending from the areola portion;
wherein the breast portion extends at a first angle relative to an axis of the base portion and the areola portion extends at a second angle relative to the axis of the base portion, wherein the first angle is greater than the second angle.

2. A nipple according to claim 1, wherein the breast portion and the areola portion provide a latch portion, and the latch portion comprises at least one elongate recess extending circumferentially around an inner surface thereof.

3. A nipple according to claim 1, wherein the breast portion and the areola portion provide a latch portion, and the latch portion comprises a plurality of discrete, circumferentially spaced, elongate recesses extending circumferentially around an inner surface thereof, the plurality of discrete, elongate recesses forming a discontinuous ring of recesses.

4. A nipple according to claim 3, wherein the discrete, elongate recesses are arranged in a repeating pattern along the discontinuous ring.

5. A nipple according to claim 1, wherein the breast portion and the areola portion provide a latch portion, and the latch portion comprises a plurality of discrete, elongate recesses extending circumferentially around an inner surface thereof, and being positioned at discrete positions along an axial direction of the latch portion, to form a plurality of axially spaced, discontinuous rings of recesses.

6. A nipple according to claim 5, wherein the plurality of discrete, elongate recesses are arranged in a repeating pattern along each discontinuous ring.

7. A nipple according to claim 6, wherein the discrete, elongate recesses of each discontinuous ring is arranged such that ends of the discrete, elongate recesses are circumferentially offset from ends of the discrete, elongate recesses of any adjacent discontinuous rings.

8. A nipple according to claim 7, wherein a centre point between any two adjacent, discrete, elongate recesses on each of the discontinuous rings is substantially circumferentially aligned with a circumferential centre point of one of the discrete, elongate recesses on any adjacent discontinuous rings.

9. A nipple according to claim 5, wherein one of the discontinuous rings is located at a position where the breast portion joins the areola portion.

10. A nipple according to claim 9, wherein any further discontinuous rings are located on the breast portion.

11. A nipple according to claim 5, wherein the plurality of discontinuous rings are arranged concentrically.

12. A nipple according to claim 2, wherein each recess provides a region of reduced wall thickness.

13. A nipple according to claim 2, wherein the latch portion has a smooth outer surface at the or each recess.

14. A nipple according to claim 1, wherein the breast portion is frustoconical in shape.

15. A nipple according to claim 1, wherein the breast portion comprises a plurality of portions each portion having a different angle, relative to the axis of the base portion, to that of any adjacent portions, wherein one of the plurality of portions, which is adjacent to the areola portion, extends at the first angle.

16. A nipple according to claim 15, wherein each of the plurality of portions of the breast portion is frustoconical in shape.

17. A nipple according to claim 1, wherein the areola portion is frustoconical in shape.

18. A nipple according to claim 1, wherein the breast portion, the areola portion and the teat portion are provided by a continuous outer wall.

19. A nipple according to claim 1, wherein the teat portion extends from the areola portion at a shoulder portion, and wherein a diameter of the areola portion adjacent to the shoulder portion is greater than a diameter of the teat portion adjacent to the shoulder portion.

20. A nipple according to claim 19, wherein the breast portion, the areola portion, the teat portion and the shoulder portion are provided by a continuous outer wall.

21. A nipple according to claim 1, wherein the nipple is provided by a continuous outer wall.

22. A nipple assembly for use with an infant drinking vessel, the nipple assembly including a nipple according to claim 1 and a collar.

23. A feeding assembly for use with an infant drinking vessel, the feeding assembly including a nipple according to claim 1 and a container.

24. A feeding assembly according to claim 23, the feeding assembly further comprising a collar for securing the nipple to the container.

25. A comforter assembly for comforting an infant, the comforter assembly including a nipple according to claim 1.
